(19) United States
(12) Patent Application Publication
(10) Pub. No.: US 2009/0070122 A1
(43) Pub. Date: Mar. 12, 2009

(54) ESCROW SERVICE FOR PROVIDING LICENSED DIGITAL CONTENT

(75) Inventors: Jerry Hauck, Windermere, FL (US); Michael Culbert, Monte Sereno, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/854,128

(22) Filed: Sep. 12, 2007

(51) Int. Cl. G06Q 40/00; G06F 17/00

(52) U.S. Cl. 705/1

(57) ABSTRACT

Physical media containing digital content can be exchanged for a license to download an electronic copy of the digital content. In an implementation, the physical media is received at a kiosk and secured such that it is not accessible to the user after the license is granted. The license provides the user with rights to download the digital content to a personal computer, set-top box, gaming device, portable video player or portable image viewer having digital rights enforcement.

### TECHNICAL FIELD

The subject matter of this patent application is generally related to digital media rights management.

### BACKGROUND

Digital content, such as movies on DVD, can be copy protected by digital rights management (DRM) techniques to prevent unauthorized copies from being made and distributed without a copyright owner's consent. The DRM techniques allow individuals to play digital content on a player, such as a DVD player or a software application, by inserting the physical media on which the content is stored. However, for the home viewer with multiple DVD players and/or personal computing devices, this requires the viewer insert the physical media when they wish to view the content. In addition, users typically cannot copy the digital content to a media server for viewing on multiple devices.

### SUMMARY

Physical media containing digital content can be escrowed in exchange for a license to download an electronic copy of the digital content into a personal computer, set-top box, gaming device, portable video player or portable image viewer. The physical media held in escrow can be stored, physically destroyed, or placed into the rental/resale market. The license can include restrictions on use and/or redistribution of the downloaded digital content.

In some implementations, a method includes: receiving physical media including first content; identifying the first content on the physical media; receiving input specifying second content; providing a license defining user rights for accessing the second content; and preventing access to the physical media.

In some implementations, a system includes a receiver to receive physical media, a media reader to read first content stored to the physical media, a display, an input device to receive user inputs, and a secure inventory storage unit to store the physical media. The system can provide a license to the second content in exchange for the physical media received by the system.

In some implementations, a method includes: receiving first digital content on physical media; ascertaining rights associated with the first digital content; securing the physical media; and granting a license to second digital content in accordance with the first digital content and the securing of the physical media.

Other implementations are disclosed, including implementations directed to systems, methods, apparatuses, computer-readable mediums and user interfaces.

### DESCRIPTION OF DRAWINGS

FIG. 1 is a block diagram of an example system for escrowing physical media.

FIGS. 2A-2C illustrate example user interfaces for the system illustrated in FIG. 1.

FIG. 3 is a flow diagram of an example process for escrowing physical media in exchange for a license to download an electronic copy.

### DETAILED DESCRIPTION

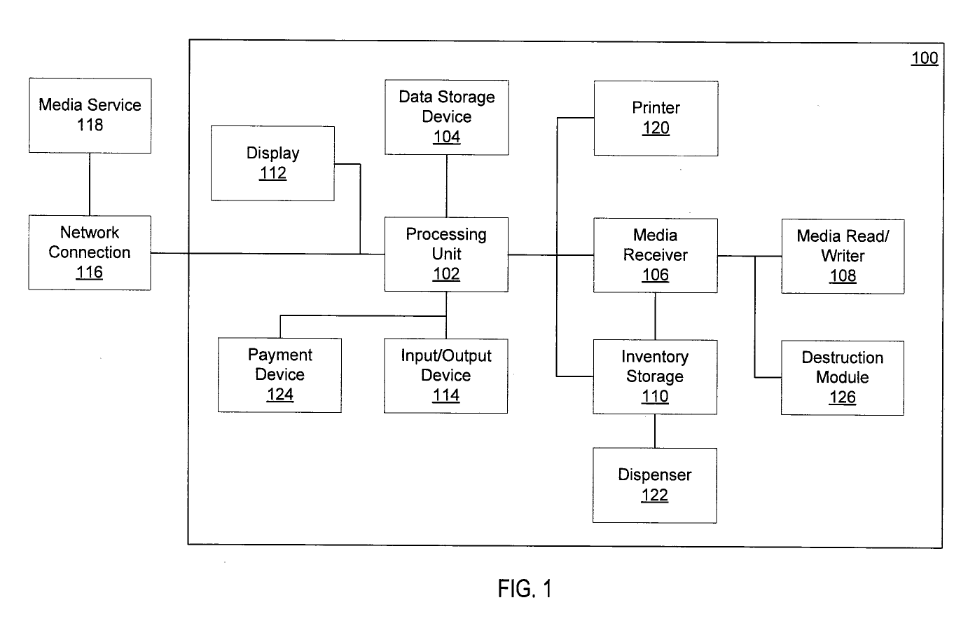

FIG. 1 is a block diagram of a system 100 for escrowing CDs, DVDs or other physical media. In some implementations, the system 100 can be an interface to a service that escrows an owner's physical media containing digital content (e.g., movies, music and/or games) in exchange for a license to an electronic copy of the digital content into a personal computer, set-top box, gaming device, portable video player or portable image viewer. The physical media held in escrow can be stored, physically destroyed, or placed into the rental/resale market with adequate compensation provided to the copyright holder, etc. The license can include restrictions on use and/or redistribution of the downloaded digital content. For example, the license policy may allow a user to make unlimited copies, or the license may be more restrictive and limit a total number of copies, or time expire subsequent copies. In some implementations, the license can be exchanged for the return of physical media containing the digital content.

In some implementations, the system 100 can be housed in a kiosk or similar structure that is readily accessible to individuals desiring to acquire rights to download the digital content contained on the physical media. For example, the kiosk can be placed in a retail store. The system 100 includes a processing unit 102, such as, without limitation, a microprocessor. A data storage device 104, such as, without limitation, a hard drive, flash memory, or the like, is in electronic communication with processing unit 102. The data storage device 104 can store information regarding the physical media escrowed in the system 100.

In some implementations, the system 100 includes a media receiver 106 that receives the physical media from users to be escrowed. For example, the physical media escrowed by users can be stored in a secure inventory storage unit 110. The physical media received by the media receiver 106 can be transported by a mechanism to the secure inventory storage unit 110, which can hold the physical media in escrow while the user license for the downloaded copy is active. When the license expires, the user can return and retrieve the physical media from the system 100 or the physical media can be resold/rented to others.

In some implementations, the system 100 destroys the physical media such that it cannot be reused after the license is granted to download a copy of the digital content that was contained on the physical media. For example, a destruction module 126 can deposit an optical interference agent onto an escrowed CD or DVD to make it unreadable. In some implementations, the optical interference agent is reversible to restore normal use of the disk after expiration/revocation of the license that is issued to the user who places the physical media in escrow.

In some implementations, the destruction module 126 can implement a one-way physical destruction process where the physical media is shattered, punched, abraded or otherwise rendered inoperative. Shattering the physical media provides for a rapid method of media destruction. Punching or abrading (e.g., in a pseudo-random pattern) enables robustness checks to ensure that the physical media destruction process has not been circumvented. For example, by limiting destruction to a randomly selected segment, track or feature of the physical media, a media read/writer 108 can be provided to read destroyed and undestroyed locations to confirm that the physical media has been destroyed, while also confirming that the physical media contained the digital content for which the license will be issued to the user to download.

In some implementations, the media read/writer 108 or the destruction module 126 can overwrite random areas of the physical media, thus destroying the digital content contained on the physical media. For example, the media read/writer 108 can be an optical media recorder having a high-powered laser to burn through selected portions of the reflective layer on a CD or DVD such that an inspection of the disk would rapidly indicate that the disk was placed into escrow.

In some implementations, the system 100 can display one or more graphical user interfaces a display 112 for providing access to various system functions and applications, and for conveying information to the user. An input/output device 114, such as a keyboard, display, touch screen, Bluetooth™ wireless interface or the like, enables a customer to provide instructions, such as user identification information, payment information, or other instructions to the system.

The system 100 can interface with a network connection 116 such that it is in communication with a media service 118 that, for example, provides access to media files, such as song files, movie files, video clips, and other media data. The network connection 116 can be a dial-up connection, Ethernet connection, cellular connection, a Wi-Fi, or a WiMax network, etc. The media service 118 can be a service such as iTunes® that provide access to user account information and multimedia content, and that provides the media files to the user in accordance with the license.

In some implementations, a payment device 124 is in electronic communication with the processing unit 102. The payment device 124 is adapted to accept currency, or to read credit cards and debit cards, or other instruments for purposes of obtaining payment/exchange information for the desired transaction (e.g., the purchase of digital content on physical media, information to ascertain the license, or information related to the exchange of a license for physical media). The payment/exchange information is then transmitted to processing unit 102 for processing thereby in a known manner. In some implementations, the payment device 124 can be a user interface presented on the display 112 wherein a user can enter payment information and/or instructions.

In some implementations, the system 100 can sell digital content on physical media. For example, the media read/writer 108 can selectively write digital content to blank physical media stored in the system 100. In some implementations, the system 100 can include a printer 120 that can be used to print an image on the physical media or its protective sleeve to identify which title is recorded onto the physical media.

In some implementations, the system 100 can directly resell the physical media retained in the secure inventory storage unit 110. For example, the data storage device 104 can retain a local inventory of physical media stored in the secure inventory storage unit 110. When a user purchases physical media from the secure inventory storage unit 110, the physical media can be transported to a dispenser 122, which in turn dispenses the physical media to a user.

In some implementations, the inventory storage unit 110 can include or be operatively coupled to a transport mechanism that, on command, transports the physical media to destruction module 126 for destruction, as noted above, in accordance with predetermined physical media retention guidelines.

In some implementations, the system 100 can be a peripheral that connects to a computing device, such as personal computer, set-top box, gaming device, portable video player or portable image viewer. The peripheral can implement one or more of the functions noted above to enable a user to download an electronic copy of the digital content in accordance with a license for archival purposes, digital jukeboxes, drive-less media players/computers.

In some implementations, the system 100 can be remotely located and users would mail, courier, hand-carry, etc. the physical media for processing. The physical media would be processed to determine the digital content contained thereon and a user's account credited such that the user can download a copy of the digital content. Upon processing, an e-mail, text message, or other notification can be sent to the user indicating that their account has been credited.

### Exemplary User Interface

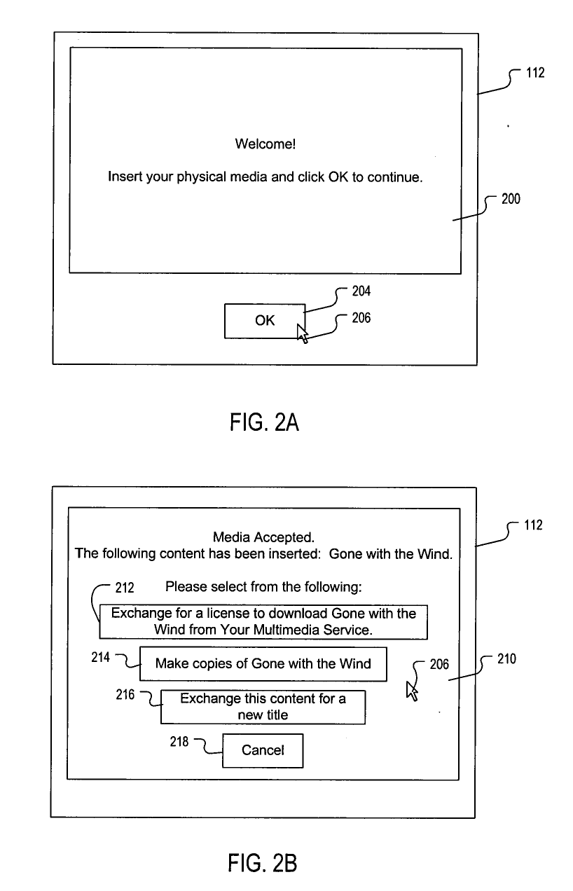

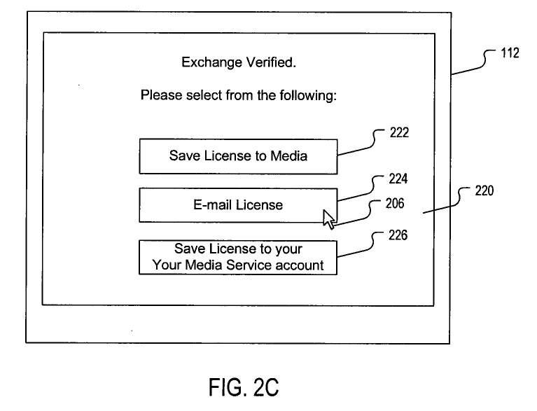

FIG. 2A is an exemplary user interface 200 to the system 100. In some implementations the user interface is provided on the display 112 to guide a user's interaction with the system 100. For example, a user interface 202 welcoming a user can be provided to begin the process of escrowing physical media. As illustrated in FIG. 2A, the user is instructed to insert the physical media, e.g. into the media receiver 106, and click OK, which is displayed in the option box 204. The user indicates an input using an input device 206. The input device 206 can accept inputs such as: keyboard, voice, gestures, etc.

FIG. 2B is another exemplary user interface 210 to the system 100. In some implementations, the user interface 210 can be provided after the physical media is accepted by the system 100 from the user. The user interface 210 provides an indication that the media has been accepted and provides additional options 212, 214, 216 and 218 to the user. For example, the user can exchange the physical media for a license to download an electronic copy of the content contained on the physical media (e.g. “Gone with the Wind”) by selecting option 212. In some implementations, the user is provided in option 214 to make copies of the digital content contained on the physical media. For example, the user can be provided an option to make a copy of the digital content onto some other media or using the media read/writer 108. In some implementations, a copy of the digital content can be transmitted using the network connection 116 to a wireless or wired device (e.g., iPod, iPhone, Apple TV).

In some implementations, the user is provided in option 216 to exchange the digital content contained on the physical media for a new digital content. For example, the user may wish to exchange “Gone with the Wind” for another movie title. The user interface 210 can provide a cancel option 218 if the user desire to cancel or quit the interaction with the system 100. The user indicates an input using the input device 206.

FIG. 2C is another exemplary user interface 220 to the system 100. In some implementations, the user interface 220 can be provided after the user indicates a selection in the user interface 210. For example, if the user selected option 212 in the user interface 210, the system 100 verifies the exchange, and provides options 222, 224 and 226. In some implementations, the user is provided an option 222 to save a license to removable media, such as a floppy disk, flash media, or communicated to a portable device over a short range wireless link, such as Bluetooth™.

In some implementations, the user can select an option 224 to e-mail or electronically communicate the license to a destination, such as an e-mail account, or an FTIP address. In some implementations, the user can select an option 226 to save the license to a media service account, such as an account on the media service 118. The user can later log onto the media service 118, access his/her account information and license, and download electronic content.

### Exemplary Physical Media Escrowing Process

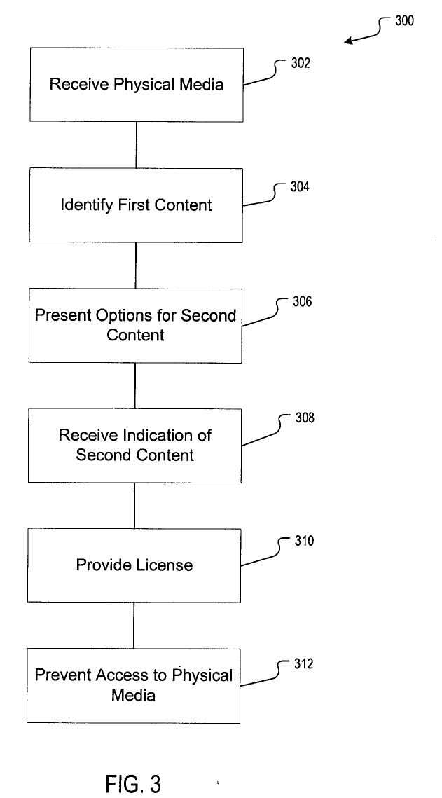

FIG. 3 is a flow diagram of an example process 300 for escrowing physical media in exchange for a license to download an electronic copy to a personal computer, set-top box, gaming device, portable video player or portable image viewer. In an implementation, the example process 300 can be implemented as instructions stored in the data storage device 104 and executed on the processing unit 102 and/or instructions executed by the media service 118. At stage 302, physical media is received. For example, a user may insert the physical media into the media receiver 106 for verification by the system 100.

At stage 304, first content is identified. For example, the physical media can be read by the media read/writer 108 to determine content contained on the physical media. In some implementations, the content can be determined by querying the media service 118 based on information retrieved from the physical media.

At stage 306, options are presented. For example, the system 100 presents options on the display 112, such as shown in the user interface 210.

At stage 308, an indication of second content is received. For example, a user selection of one of options 212, 214 or 216 is received by the system 100 by the input/output device 114.

At stage 310, a license to the second content is provided. For example, in response to the user input received at stage 308, the system 110 provides the user interface 222 to receive an indication of how to provide the license to the user. The license is provided in accordance with the user selection of one of options 222, 224 or 226. In some implementations, a confirmation number is provided to the user as a confirmation of the license grant.

At stage 312, access to the physical media is prevented. For example, the destruction module 126 can destroy the physical media or the system 100 can store the physical media in the secure inventory storage 110 such that access to the content on the physical media is prevented while the license is in effect.

The disclosed embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the disclosed implementations and still be within the scope of the following claims.

What is claimed is:

1. A method comprising:
receiving physical media including first content;
identifying the first content on the physical media;
receiving input specifying second content;
providing a license defining user rights for accessing the second content; and
preventing access to the physical media.

2. The method of claim 1, where preventing access to the physical media further comprises:
destroying the physical media.

3. The method of claim 2, further comprising:
punching a hole in the physical media.

4. The method of claim 2, further comprising:
overwriting a predetermined portion of the physical media.

5. The method of claim 2, further comprising:
abrading a surface of the physical media.

6. The method of claim 2, further comprising:
verifying destruction of the physical media.

7. The method of claim 1, further comprising:
determining the user rights of the license in accordance with rights associated with the first content.

8. The method of claim 1, further comprising:
expiring the license after a predetermined period of time.

9. The method of claim 1, comprising:
receiving an e-mail address; and
communicating the license to the e-mail address.

10. The method of claim 8, comprising:
receiving user account information associated with a media service; and
providing the license to the user account.

11. The method of claim 1, comprising:
downloading the license to removable media.

12. The method of claim 1, comprising:
communicating a portion of the first content to a media service; and
determining a title of the first content based on a response provided by the media service.

13. The method of claim 1, comprising:
storing the physical media in a container.

14. The method of claim 1,
wherein the physical media is one of optical media, magnetic media, or flash media.

15. The method of claim 1,
wherein the first content and second content are one of movies, music, television shows, or videos.

16. The method of claim 1, comprising:
providing a confirmation of the license.

17. A system, comprising:
a receiver to receive physical media;
a media reader to read first content stored to the physical media;
a display;
an input device to receive user inputs; and
a secure inventory storage unit to store the physical media,
wherein a license to the second content stored on the physical media is provided in exchange for the physical media received by the system.

18. The system of claim 17, further comprising:
a destruction module to destroy the physical media.

19. The system of claim 18, further comprising:
a verification module to verify the destruction of the physical media.

20. The system of claim 17, further comprising:
receiving user account information associated with a media service; and
providing the license to the user account.

21. The system of claim 17,
wherein a portion of the first content is communicated to a media service, and wherein a title of the first content is determined based on a response provided by the media service.

22. The system of claim 17,
wherein the physical media is one of optical media, magnetic media, or flash media.

23. The system of claim 17,
wherein the first content and second content are one of movies, music, television shows, or videos.

24. The system of claim 17,
wherein a confirmation of the license is provided.

25. A method, comprising:
receiving first digital content on physical media;
ascertaining rights associated with the first digital content;
securing the physical media; and
granting a license to second digital content in accordance with the first digital content and the securing of the physical media.

26. The method of claim 25, further comprising:
receiving input associated with an account holder and a selection of the second digital content; and
communicating the license to the account holder.

27. The method of claim 25, further comprising:
destroying the physical media.

28. The method of claim 25,
wherein the first digital content and second digital content are one of movies, music, television shows, or videos.
